(19) United States
(12) Patent Application Publication
(10) Pub. No.: US 2004/0111285 A1
(43) Pub. Date: Jun. 10, 2004

(54) Method for human pluripotent stem cells

(76) Inventors: Mark Germain, Scarsdale, NY (US); David G. Perryman, Atlanta, GA (US); David E. Huizenga, Lawrenceville, GA (US)

Correspondence Address: NEEDLE & ROSENBERG, P.C., SUITE 1000, 999 PEACHTREE STREET, ATLANTA, GA, 30309-3915, US

(21) Appl. No.: 10/412,135

(22) Filed: Apr. 9, 2003

Related U.S. Application Data
(60) Provisional application No. 60/371,438, filed on Apr. 9, 2002.

(51) Int. Cl. G06F 17/60

(52) U.S. Cl. 705/1; 705/35

(57) ABSTRACT

This method provides a method relating to pluripotent stem cells, such as embryonic stem cells, to make the cells widely accessible but provide sufficient financial incentive to the provider of the cells. The method comprises obtaining the pluripotent stem cells and making the cells widely available to the public such that profit and non-profit institutions can afford research and commercial access to the cells.

U.S. Provisional Application No. 60/371,438, filed on Apr. 9, 2002, is hereby incorporated by reference in its entirety.

This method provides a method relating to pluripotent stem cells, such as embryonic stem cells, to make the cells widely accessible but provide sufficient financial incentive to the provider of the cells. The method comprises obtaining the pluripotent stem cells and making the cells widely available to the public such that profit and non-profit institutions can afford research and commercial access to the cells. In one embodiment, the licensed access to the cells does not require an up front fee. In another embodiment, any cells or other downstream discoveries derived by the pluripotent stem cells can be completely exploited by the licensee with a royalty on the downstream cells or discoveries of less that 2%. In an alternative embodiment the license fee is 1%, ½%, ¼%, ⅛%. In this embodiment, the only fee on the entire transaction the licensee must pay to the licensor is the minimal royalty, i.e., no upfront or milestone fess. Alternatively, these license fees can also be utilized with an upfront fee, e.g., $1,000, $2,000, $ 3,000, $4,000, $10,000, $25,000, $50,000, $75,000 or less than $100,000 and/or a milestone fee. In each of these embodiments, once a therapeutically relevant downstream cell or other downstream discovery is made by the licensee, no fees are paid to the licensee, royalty or otherwise, for access to the pluripotent stem cells. Rather, the royalty is only paid on the downstream cells or exploitation of the downstream discoveries. Thus, the license can include the right to sub-license the pluripotent stem cells.

A commercial license can be offered for all types of cells a pluripotent cell can differentiate into, i.e. all therapeutic fields. Alternatively, it can be offered only for certain fields, e.g. hepatic, hematopoietic, neural, cardiomyocyte or pancreatic islet cells.

In a further embodiment, the licensor keeps the various pluripotent stem cells catalogued via software such that a request for a licensee activates the use of the software to complete the transaction and facilitates the delivery of the cells to the licensee. For example, the pluripotent stem cells are catalogued by their DR antigen presentation for use in cell matching to prevent immune rejection. For example, a request triggers the entry of a requested DR, the selection of a pluripotent stem cell from the database and the delivery of that cell type to the requester.

What is claimed is:

1. A method of making pluripotent stem cells widely accessible for commercial use while providing sufficient financial incentive to the provider of the cells comprising obtaining the pluripotent stem cells and offering a commercial license to the cells with a royalty of 2% or less of net sales.

2. The method of claim 1, wherein the royalty is 1% or less.

3. The method of claim 1, wherein the royalty is ½%, ¼%, or ⅛% or less.

4. The method of claim 1, further comprising a right to sub-license.

5. The method of claim 1, further comprising an upfront fee of less than $100,000.

6. The method of claim 1, further comprising an upfront fee of less than $1,000, $2,000, $3,000, $4,000, $10,000, $25,000, $50,000, or $75,000.

7. The method of claim 1, further comprising an upfront fee of about $0.

8. The method of claim 1, wherein the commercial license is to a for-profit company.

9. The method of claim 1, wherein the pluripotent cell is an ES cell.

10. The method of claim 1, further comprising computer software to implement the method.

11. The method of claim 1, wherein the commercial license is for all fields.

12. The method of claim 1, wherein the commercial license is for the fields of neural, cardiomyocyte or pancreatic islet cells derived from ES cells.
